(19) United States
(12) Patent Application Publication
(10) Pub. No.: US 2008/0241515 A1
(43) Pub. Date: Oct. 2, 2008

(54) SLIDING MEMBER

(75) Inventors: Takuya TANAKA, Inuyama (JP); Masahito Fujita, Inuyama (JP)

Correspondence Address: BROWDY AND NEIMARK, P.L.L.C.;624 NINTH STREET, NW, SUITE 300, WASHINGTON, DC, 20001-5303, US

(73) Assignee: DAIDO METAL COMPANY LTD., Nagoya (JP)

(21) Appl. No.: 12/055,838

(22) Filed: Mar. 26, 2008

(30) Foreign Application Priority Data
Mar. 26, 2007 (JP) 2007-078947

(51) Int. Cl. B32B 5/16

(52) U.S. Cl. 428/330

(57) ABSTRACT

In a sliding member, a coating layer containing a binder resin and a solid lubricant is formed on a surface of a bearing alloy layer or a base material. A flaky metal is added as a thermally conductive filler to the coating layer. The flaky metals are close to one another, or in contact with one another to form a heat transfer path which transfers heat of the surface of the coating layer to the base material. The thermal conductivity of the coating layer is set to 0.4 W/m·K or more, so that the heat generated on the surface of the coating layer due to rotation of a mating shaft is easily released to a bearing alloy layer 1 side, the reduction in strength of the coating layer can be suppressed, and conformability and anti-seizing property are enhanced.

### BACKGROUND OF THE INVENTION

1. Field of the Invention

The present invention relates to a sliding member in which a coating layer including a binder resin and a solid lubricant is provided on a base material surface.

2. Description of Related Art

As a sliding member such as a plain bearing used in an engine of a motor vehicle, the one in which an Al or Cu bearing alloy is bonded to a back metal has been used in general. However, in recent years, with increase in engine output and increase in engine rotation speed, improvement in sliding characteristics such as initial conformability and anti-seizing property become required, and in order to respond to these requirements, it becomes common to provide a coating layer on a surface of a bearing alloy layer.

As a coating layer, there are a metal coating layer including an Sn alloy layer or the like, and a resin coating layer in which a solid lubricant or the like is contained in a base resin. JP-A-07-238936 and JP-A-2000-240657 disclose the plain bearing provided with the resin coating layer. The coating layer disclosed in JP-A-07-238936 is formed by using a thermosetting resin such as a polyimide resin, an epoxy resin and a phenol resin as a base resin, and adding a solid lubricant such as molybdenum sulfide (hereinafter, called MoS₂) and graphite (hereinafter, called Gr) to the base resin. The coating layer disclosed in JP-A-2000-240657 is formed by using a thermosetting resin such as a polyimide resin, an epoxy resin and a phenol resin as a base resin, and adding an easily sulfurizable soft metal particle made from Cu, Sn, Ag, Zn and the like to the base resin.

In the meantime, the base resin will be called a binder resin hereinafter in the sense that an additive is combined therewith.

### BRIEF SUMMARY OF THE INVENTION

In JP-A-07-238936, it is said that the binder resin constituting the coating layer exhibits the conformability by being worn by a mating shaft, and the solid lubricant has the conformability as well as an effect of reducing a friction coefficient.

In JP-A-2000-240657, it is said that the easily sulfurizable soft metal particle in the coating layer reacts with sulfur in lubricant oil to form sulfide excellent in lubricity on a particle surface so that the effect of reducing the friction coefficient is provided.

However, since the resin coating layer includes a resin with low thermal conductivity as a base resin, the thermal conductivity thereof is low, and it is difficult to release heat generated on a resin coating layer surface due to rotation of the mating shaft to a bearing alloy layer side. In the resin coating layer with low heat radiation to the bearing alloy layer side like this case, there is the case that the resin coating layer reaches a high temperature during rotation of the mating shaft to reduce strength and hardness, resulting in break away and seizure.

When the resin coating layer is made thin (for example, less than 3 μm), the heat release amount to the bearing alloy layer can be increased, and reduction in strength and hardness can be suppressed to some extent. However, even though the heat release performance is improved when the resin coating layer is made thin, there is a limit to increase in heat release amount of the resin coating layer which is originally low in thermal conductivity. Therefore, rise in temperature cannot be avoided, and reduction in strength and hardness due to temperature rise cannot be avoided. In the meantime, the surface of the bearing alloy layer is generally roughened to be in a recessed and projected state in order to enhance adhesiveness to the resin coating layer. If the thin resin coating layer reduces in hardness, a local load acts on the resin coating layer at the projected portions of the bearing alloy layer which is in the recessed and projected state, and the problems of break away at that portions and of leading to seizure due to insufficient conformability occur.

### BRIEF SUMMARY OF THE INVENTION

The present invention is made in view of the above described circumstances, and an object of the present invention is to provide a sliding member in which a coating layer including a binder resin and a solid lubricant is provided on a base material surface, so that thermal conductivity of the coating layer can be enhanced to improve heat release performance to a base material side, and excellent anti-seizing property can be obtained even if the coating layer is made thin.

In order to attain the above described object, the invention defined in claim 1 is characterized by adding one or more of a flaky metal, a potassium titanate whisker and a carbon black to the coating layer as a thermally conductive filler, so that and the thermal conductivity of the coating layer is made 0.4 W/m·K or more.

In the present invention, the coating layer is provided on the surface of the base material (which is generally made from a metal). As a base material on which the coating layer is provided, various forms are conceivable. Generally, in a plain bearing in which a bearing alloy is provided on a steel back metal, it is often the case that a bearing alloy layer is used as a base material, and the coating layer is formed on a surface of the bearing alloy layer. It is also possible to use the steel back metal itself as a base material and form the coating layer on the surface of the steel back metal. In this case, in order to improve the adhesiveness of the coating layer, a porous metal layer may be provided by sintering or thermally spraying a Cu alloy for example, onto the surface of the steel back metal. By providing the coating layer on the base material surface, the conformability and the anti-seizing property can be enhanced. As a binder resin of the coating layer, a thermosetting resin such as a polyimide resin, an epoxy resin and a phenol resin can be used. A heat-resistant resin such as polyamide-imide (hereinafter, called PAI) and polybenzimidazole (hereinafter, called PBI) can be also used.

By making the coating layer contain a solid lubricant, the friction coefficient can be reduced, and the conformability can be enhanced. As a solid lubricant, one or more of MoS₂, Gr, polytetrafluoroethylene (hereinafter, called PTFE), tungsten disulfide (hereinafter, called WS₂) and the like can be used.

The coating layer may contain a hard particle in addition to the solid lubricant for enhancement of wear resistance. Further, as with JP-A-2000-240657, an easily sulfurizable soft metal particle may be contained so as to be utilized as a solid lubricant. As a hard particle, one or more of a nitride such as a silicon nitride (Si₃N₄), an oxide such as an aluminum oxide (Al₂O₃), a silicon oxide (SiO₂) and a titanium oxide (TiO₂), and a carbide such as a silicon carbide (SiC) can be used. As an easily sulfurizable soft metal particle, Cu, Sn, Ag, Zn and the like can be used.

The present invention is characterized in that a thermally conductive filler such as a flaky metal, a potassium titanate whisker and a carbon black is added to the coating layer provided on the base material surface as described above. When the thermally conductive filler is contained in the coating layer, the thermal conductivity of the coating layer becomes high. The reason why the thermal conductivity becomes high is that a heat transfer path is produced by the thermally conductive filler.

While FIG. 1 is a schematic view of the case in which a flaky metal 3 is contained in a coating layer 2 on a surface of a base material 1 for example, the metal 3 which is extended in the flaky shape extends widely in a plane to have a large surface area as compared to a granular metal even if the metal 3 has the same volume as the granular metal. The size of the flaky metal 3 is such an extent that it is accommodated within a square with one side of 10 μm, on average. In this manner, the flaky metals 3 which extend in a plane direction are close to one another, or have many chances to be in contact with one another, so that the path which transfers the heat of the surface of the coating layer 2 to the base material 1 is formed by the flaky metals 3 which are close to or in contact with one another.

FIG. 2 shows the case in which a potassium titanate whisker 4 is contained in the coating layer 2. In this case, the potassium titanate whisker 4 is formed into a whisker (a whisker shape), and therefore extends to be long and thin as compared to a granular one with the same volume. The size of the potassium titanate whisker 4 is about 0.5 μm in diameter, and about 20 μm in length. The long potassium titanate whiskers 4 have many chances to be close to one another, and are sometimes longer than the thickness dimension of the coating layer 2. Therefore, one potassium titanate whisker 4 may extend between the surface of the coating layer 2 and the base material 1, so that the potassium titanate whiskers 4 form a path which easily transfers the heat of the surface of the coating layer 2 to the base material 1.

FIG. 3 shows the case in which a carbon black 5 is contained in the coating layer 2. The carbon black 5 is very minute (the diameter of about 3 to 50 nm), and the number of carbon blacks 5 is significantly large as compared to the flaky metals 3 and the potassium titanate whiskers 4 exist in the same volume. Therefore, the carbon blacks 5 are close to one another, or have many chances to be in contact with one another. By these carbon blacks 5 which are close to or in contact with one another, a path which transfers the heat of the surface of the coating layer 2 to the base material 1 is formed.

The thermal conductivity of the coating layer is set to 0.4 W/m·K or more by addition of such a thermally conductive filler.

The content amount of the thermally conductive filler to be added to the coating layer is preferably 5 to 20 volume % in the case of the flaky metal (claim 2), is preferably 1 to 15 volume % in the case of the potassium titanate whisker (claim 3), and is preferably 1 to 10 volume % in the case of the carbon black (claim 4). In the case that the content amount is within these ranges, the coating layer excellent in thermal conductivity can be easily formed.

The content amount in the case of adding two or more of the flaky metal, potassium titanate whisker and carbon black are added to the coating layer as a thermally conductive filler is preferably 25 volume % or less in total amount (claim 5). In the case that the content amount is within this range, the thermal conductivity is excellent, and a low friction coefficient can be reliably maintained.

When the thermally conductive filler is added to the coating layer, the thermal conductivity of the coating layer can be enhanced as described above. In the coating layer with a high thermal conductivity (0.4 W/m·K or more), heat generating in the coating layer surface due to rotation of the mating shaft is favorably transmitted from the coating layer to the bearing alloy layer, and therefore the coating layer can be prevented from reaching an abnormal high temperature. Therefore, reduction in strength and hardness of the coating layer can be suppressed. Further, the thermal conductive filler is relatively high in hardness, and therefore the hardness of the coating layer is increased by adding the thermally conductive filler. In this case, the hardness of the coating layer is preferably HV20 to HV40 (claim 6). Within this range, the coating layer is hardly influenced by the recesses and projections on the base material surface, and even if a local load at the projected portion of the base material surface is applied thereto, occurrence of a crack, breakage and the like of the coating layer can be prevented. Accordingly, occurrence of abrasive wear caused by foreign matters which are exfoliated pieces of the coating layer generated due to a crack, breakage or the like can be prevented. In addition, since the conformability is favorable, it is possible to prevent a load from being locally exerted.

In the present invention, the thickness of the coating layer to which the thermally conductive filler is added can be made less than 3 μm (claim 7). In this case, the thickness of the coating layer is measured based on the microscopic method of JISK5600. When the surface of the base material 1 is in the recessed and projected form as shown in FIG. 5, a distance T from the vertex of the projected portion (or from the average of the heights of the vertexes of the projected portions in a predetermined range if the heights of the projected portions differ) to the surface of the coating layer (or to the average of the heights of the vertexes of the projected portions in a predetermined range if recesses and projections are present) is regarded as the thickness of the coating layer. Since the coating layer of the present invention is excellent in thermal conductivity as described above, heat generating in the surface of the coating layer is easily transmitted to the base material, so that reduction in strength of the resin due to the heat generating on the surface of the coating layer hardly occurs. Accordingly, even if the thickness of the coating layer is made thin, the coating layer is hardly influenced by the recesses and projections on the surface of the bearing alloy layer, and occurrence of a crack, breakage or the like of the coating layer can be prevented.

### BRIEF DESCRIPTION OF THE SEVERAL VIEWS OF THE DRAWINGS

FIG. 1 is a sectional view schematically showing a state of a coating layer to which flaky metals are added in the present invention;

FIG. 2 is a sectional view schematically showing a state of a coating layer to which potassium titanate whiskers are added in the present invention;

FIG. 3 is a sectional view schematically showing a state of a coating layer to which carbon blacks are added in the present invention;

FIG. 4 is a sectional view of a plain bearing showing an embodiment to which the present invention is applied; and

FIG. 5 is a schematic view showing the relationship between recesses and projections of a bearing alloy layer surface, and the thickness of a coating layer.

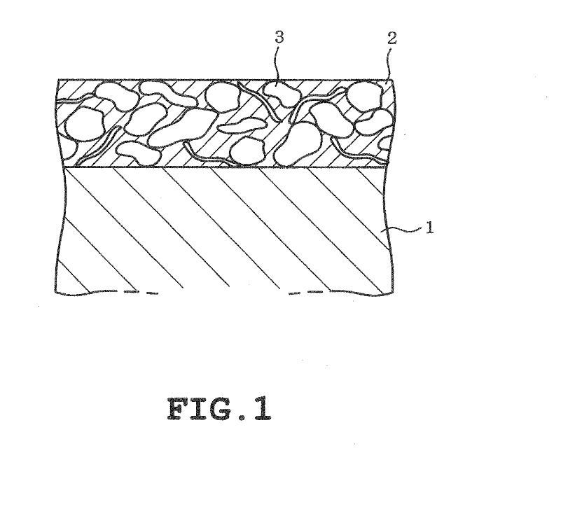

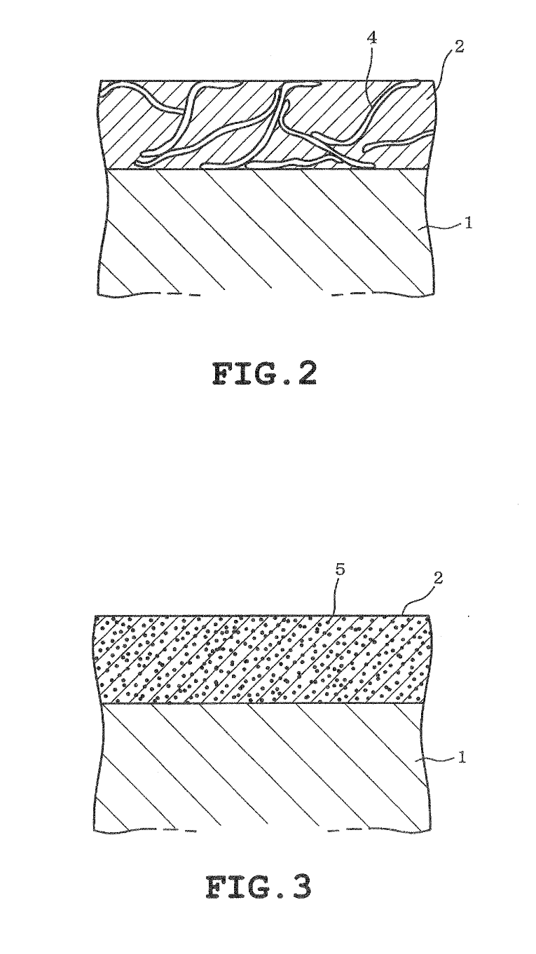

### DETAILED DESCRIPTION OF THE INVENTION

Hereinafter, the present invention will be described in detail based on an embodiment.

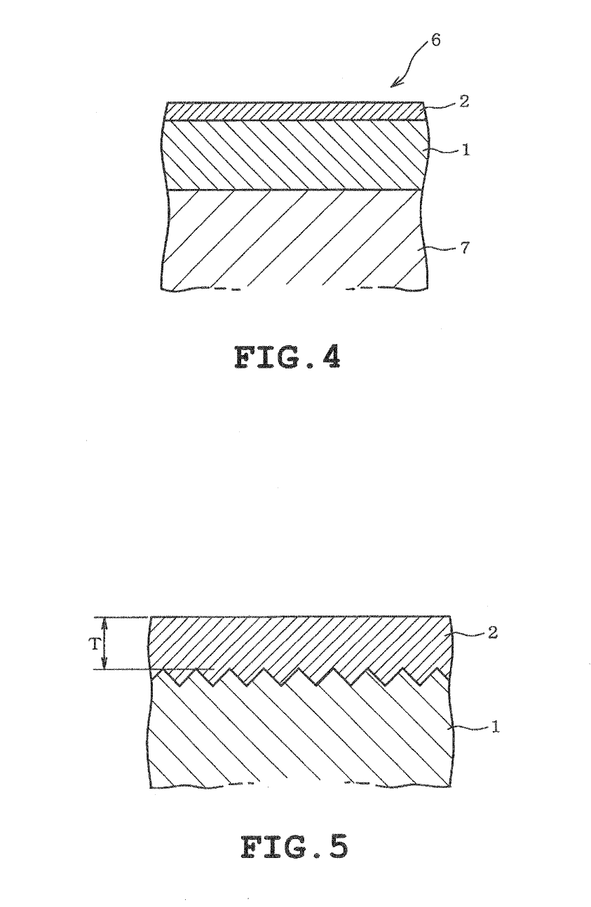

A basic form of a sliding member to which the present invention is applied is shown in FIG. 4. A sliding member 6 of FIG. 4 is configured as a plain bearing for an engine, for example, and has a three-layer structure of a back metal layer 7 including steel, a bearing alloy layer 1 provided on a surface of the back metal layer 7, and a coating layer 2 provided on a surface of the bearing alloy layer 1. As the bearing alloy layer 1, an Al or Cu alloy can be used, but in this embodiment, a Cu alloy is used.

The coating layer 2 is formed by adding a solid lubricant to a binder resin. As the binder resin, a thermosetting resin such as a polyimide resin, an epoxy resin and a phenol resin, and a heat resistant resin such as PAI and PBI can be used. As the solid lubricant, one or more of MoS₂, Gr, PTFE, WS₂ and the like can be used.

A method for manufacturing the sliding member 6 is as follows. First, a Cu sintered alloy is sprayed onto the surface of the back metal layer 7, is sintered in a reducing atmosphere furnace, and is then rolled by a roll. This process is repeated twice, so that a bimetal in which the bearing alloy layer 1 is coated on the back metal layer 7 is obtained. Then, the bimetal is machined into a predetermined shape to manufacture the sliding member 6 such as the above described plain bearing for the engine.

The present inventors obtain a plurality of sample pieces by cutting the bimetal manufactured in the above manner into a predetermined shape. Subsequently, roughening is performed so that the roughness of the surface of the bearing alloy layer of each of the sample pieces becomes the maximum height (Rmax) of 1.5 to 2 μm.

In the meantime, coating liquids are produced by adding the solid lubricants and the thermally conductive fillers composed of the components shown in Table 1 to the binder resins shown in the following Table 1 so as to be the compositions shown in Table 1 and further, diluting those with an organic solvent. The coating liquids are applied to the roughened bearing alloy surfaces of the sample pieces by means of a roll printing method (a method of uniformly spreading a coating liquid on the roll surface and applying the coating liquid on the bearing alloy layer using the roll), for example. After coating the coating liquids, the sample pieces are passed through a drying furnace and a sintering furnace to perform drying for evaporating and removing the organic solvent from the coating liquids and to perform baking of the coating liquids to make the coating layers. The samples of examples 1 to 15 shown in Table 1 are obtained in the above manner. By a similar production method to that as described above, samples of comparative examples 1 to 8 having the coating layers with the compositions shown in Table 1 are obtained.

With respect to the coating layer of each of the samples formed in the above manner, hardness, thickness and thermal conductivity are measured. For each of the samples, the seizure test is performed under the condition shown in Table 2, and the result is shown in Table 1. In the meantime, a seizure load means a surface pressure when a sample piece causes seizure in a test where the surface pressure applied to the sample piece is increased by 1 MPa every ten minutes.

TABLE 1

| | COATING LAYER COMPOSITION (VOLUME %) | | | | | | | | | | |
|---|---|---|---|---|---|---|---|---|---|---|---|
| | | | | | | THERMALLY CONDUCTIVE FILLER | | | | | |
| | BINDER | | SOLID | | | | | | | POTASSIUM | |
| SAMPLE | RESIN | | LUBRICANT | | | SPHERICAL | FLAKY | FLAKY | FLAKY | TITANATE | CARBON |
| NUMBER | PAI | | MoS₂ | Gr | PTFE | Cu | Cu | Sn | Ag | WHISKER | BLACK |
| EXAMPLE | 1 | 55 | 40 | | | | 5 | | | | |
| | 2 | 50 | 30 | | 10 | | | 10 | | | |
| | 3 | 40 | | 40 | | | | 20 | | | |
| | 4 | 38 | 40 | | | | | | 22 | | |
| | 5 | 58 | 40 | | | | | 1 | | 1 | |
| | 6 | 44 | 40 | | | | | | 1 | 15 | |
| | 7 | 42 | 30 | 10 | | | | | 1 | 17 | |
| | 8 | 59 | 30 | 10 | | | | | | | 1 |
| | 9 | 50 | 40 | | | | | | | | 10 |
| | 10 | 48 | 40 | | | | | | | | 12 |
| | 11 | 59 | 40 | | | | | | | 1 | |
| | 12 | 50 | 40 | | | | | | | | 10 |
| | 13 | 50 | 40 | | | | | | | | 10 |
| | 14 | 50 | 40 | | | | | | | | 10 |
| | 15 | 33 | 40 | | | | | 20 | | | 7 |
| COMPARATIVE | 1 | 60 | 40 | | | | | | | | |
| EXAMPLE | 2 | 55 | 40 | | | | | | | | |
| | 3 | 60 | 30 | | | 10 | | | | | |
| | 4 | 59.5 | | 40 | | | | | | 0.5 | |
| | 5 | 59.5 | 30 | | 10 | | | | | | 0.5 |
| | 6 | 56 | 20 | 20 | | | | | 4 | | |
| | 7 | 60 | 30 | | | 10 | | | | | |
| | 8 | 60 | 40 | | | | | | | | |

| | COATING LAYER | | | | | |
|---|---|---|---|---|---|---|
| | COMPOSITION | | | | | |
| | (VOLUME %) | | COATING | COATING | COATING LAYER | |
| | BINDER | | LAYER | LAYER | THERMAL | SEIZURE |
| SAMPLE | RESIN | | HARDNESS | THICKNESS | CONDUCTIVITY | LOAD |
| NUMBER | PAI | | (HV) | (μm) | (W/m · k) | (MPa) |
| EXAMPLE | 1 | 55 | 25 | 10 | 0.42 | 26 |
| | 2 | 50 | 23 | 10 | 0.50 | 27 |
| | 3 | 40 | 27 | 10 | 0.61 | 26 |
| | 4 | 38 | 29 | 10 | 0.68 | 25 |
| | 5 | 58 | 22 | 10 | 0.40 | 26 |
| | 6 | 44 | 37 | 10 | 0.72 | 26 |
| | 7 | 42 | 42 | 10 | 0.72 | 24 |
| | 8 | 59 | 20 | 10 | 0.41 | 26 |
| | 9 | 50 | 35 | 10 | 0.55 | 27 |
| | 10 | 48 | 36 | 10 | 0.57 | 24 |
| | 11 | 59 | 22 | 5 | 0.40 | 25 |
| | 12 | 50 | 35 | 4 | 0.55 | 26 |
| | 13 | 50 | 35 | 2.5 | 0.55 | 28 |
| | 14 | 50 | 35 | 1.5 | 0.55 | 28 |
| | 15 | 33 | 38 | 10 | 0.75 | 24 |
| COMPARATIVE | 1 | 60 | 18 | 10 | 0.36 | 21 |
| EXAMPLE | 2 | 55 | 22 | 10 | 0.36 | 22 |
| | 3 | 60 | 27 | 10 | 0.37 | 23 |
| | 4 | 59.5 | 19 | 10 | 0.36 | 21 |
| | 5 | 59.5 | 20 | 10 | 0.37 | 22 |
| | 6 | 56 | 22 | 10 | 0.38 | 23 |
| | 7 | 60 | 27 | 5 | 0.36 | 18 |
| | 8 | 60 | 18 | 2.5 | 0.36 | 12 |

TABLE 2

| | TEST CONDITION | UNIT |
|---|---|---|
| TEST PIECE SIZE | OUTSIDE DIAMETER | mm |
| | 27.2 × INSIDE | |
| | DIAMETER 22.0 | |
| SPECIFIC LOAD | ACCUMULATE 1 MPa | MPa |
| | EVERY 10 min | |
| VELOCITY | 2 | m/sec |
| LUBRICANT OIL | SAE#30 | — |
| OIL TEMPERATURE | 60 | ° C. |
| LUBRICATION | OIL DROPPING | — |
| MATING SHAFT MATERIAL | S55C | — |
| MATING SHAFT HARDNESS | 500~700 | HV10 |
| MATING SHAFT ROUGHNESS | 1 μm OR LESS | Rmax |

As a result of examining the result of the seizure test, it can be understood that examples 1 to 15 in which the thermal conductivities of the coating layers are 0.4 W/m·K or more are excellent in anti-seizing property as compared to comparative examples 1 to 8 in which the thermal conductivities are less than 0.4 W/m·K.

From comparative examples 1 and 8, and comparative examples 2, 3 and 7, even when the spherical metal, more specifically, the spherical Cu is added as the thermally conductive filler, the thermal conductivity of the coating layer is not enhanced, or is enhanced only a little if it is enhanced. On the other hand, it is found out that the thermal conductivities are significantly enhanced in examples 1 to 15 in which the flaky metal, the potassium titanate whisker, and the carbon black are added as the thermal conductive filler, and the flaky metal, the potassium titanate whisker, and the carbon black are effective in enhancement in the thermal conductivity.

However, it is understood from example 1 and comparative example 6 that in order to set the thermal conductivity of the coating layer to 0.4 W/m·K or more by addition of only the flaky metals, it is necessary to add 5 volume % or more when using PAI as the binder resin. Also, it is understood from example 11 and comparative example 4 that when only the potassium titanate whiskers are added, addition of 1 volume % or more is required, and it is understood from example 8 and comparative example 5 that when only the carbon blacks are added, addition of one volume % or more is required.

It is understood from examples 1 to 15 that as the content of the thermally conductive filler increases, the thermal conductivity of the coating layer increases in proportion to that. However, from the viewpoint of the anti-seizing property, it is understood that in the case of the flaky metal, 20 volume % or less is preferable according to examples 3 and 4, in the case of the potassium titanate whiskers, 15 volume % or less is preferable according to examples 6 and 7, in the case of the carbon blacks, 10 volume % or less is preferable according to examples 9 and 10, and the total amount of the thermal conductive fillers is preferably 25 volume % or less according to examples 1 to 14 and example 15. In addition, in the case that the fillers are within these ranges, sufficient amount of solid lubricants can be contained, and therefore, the friction coefficient of the coating layer can be kept low.

As described above, examples 1 to 15 are excellent in anti-seizing property as compared to comparative examples 1 to 8. In connection with the hardness, the hardness of example 8 which is the lowest hardness is HV20, and therefore, the hardness of the coating layer is preferably set to HV20 or more. Since the anti-seizing property reduces when the hardness exceeds HV40 according to examples 6 and 7, HV40 or less is preferable.

Next, regarding the thickness of the coating layer, it is found out from comparative examples 1 and 8 that in the case of the low thermal conductivity, when the thickness is made less than 3 μm, the anti-seizing property significantly reduces. On the other hand, from examples 12 to 14, in the case of the high thermal conductivity, reduction in anti-seizing property cannot be seen even though the thickness of the coating layer is made less than 3 μm while the anti-seizing property increases on the contrary. This is considered to be because when the thermal conductivity of the coating layer is nigh, the coating layer is excellent in heat release performance so that reduction in hardness of the coating layer does not occur, and the coating layer is hardly influenced by the recesses and projections of the bearing alloy layer (base material) surface. This is also considered to be because deformation of the coating layer is less since the coating layer is thin, and the true contact area with the mating shaft becomes small to reduce the heat generation amount.

1. A sliding member comprising a base material, and a coating layer provided on a surface of the base material, the coating layer containing a binder resin and a solid lubricant, wherein
one or more kinds of a flaky metal, a potassium titanate whisker and a carbon black are added to the coating layer as a thermally conductive filler so that the thermal conductivity of the coating layer is 0.4 W/m·K or more.

2. The sliding member according to claim 1, wherein the flaky metal is added to the coating layer as the thermally conductive filler, and the content amount of the flaky metal is 5 volume % to 20 volume %.

3. The sliding member according to claim 1, wherein the potassium titanate whisker is added to the coating layer as the thermally conductive filler, and the content amount of the potassium titanate whisker is 1 volume % to 15 volume %.

4. The sliding member according to claim 1, wherein the carbon black is added to the coating layer as the thermally conductive filler, and the content amount of the carbon black is 1 volume % to 10 volume %.

5. The sliding member according to claim 1, wherein two or more kinds of the flaky metal, the potassium titanate whisker and the carbon black are added to the coating layer as the thermally conductive filler, and the total content amount of the thermally conductive filler is 25 volume % or less.

6. The sliding member according to claim 1, wherein the hardness of the coating layer is HV20 to HV40.

7. The sliding member according to claim 1, wherein the thickness of the coating layer is less than 3 μm.
